(19) United States
(12) Patent Application Publication
(10) Pub. No.: US 2026/0049647 A1
(43) Pub. Date: Feb. 19, 2026

(54) GEAR STRUCTURE AND MEDIUM PROCESSING DEVICE

(71) Applicant: CASIO COMPUTER CO., LTD., Tokyo (JP)

(72) Inventor: Masakazu SUZUKI, Tokyo (JP)

(73) Assignee: CASIO COMPUTER CO., LTD., Tokyo (JP)

(21) Appl. No.: 19/297,583

(22) Filed: Aug. 12, 2025

(30) Foreign Application Priority Data
Aug. 13, 2024 (JP) 2024-134937

(51) Int. Cl. F16H 1/20; F16H 55/08

(52) U.S. Cl. CPC F16H 1/20; F16H 55/0806; F16H 2055/0866

(57) ABSTRACT

A gear structure includes two gears meshing with each other to transmit power. In one of the two gears, some of a plurality of teeth are partially missing in a tooth width direction. The other of the two gears has engaging portions that engage with the missing tooth portions at inter-teeth portions corresponding to the partially missing teeth among a plurality of inter-teeth portions.

### CROSS-REFERENCE TO RELATED APPLICATION

The present application claims priority based on Japanese Patent Application No. 2024-134937 filed on Aug. 13, 2024, the entire contents of which are incorporated herein.

### TECHNICAL FIELD

The present disclosure relates to a gear structure and a medium processing device.

### BACKGROUND

In a gear structure that transmits power via a plurality of gears, it may be required to correctly match and assemble the phases of the plurality of gears. As a configuration for matching phases of a plurality of gears, it is known to insert a pin into a hole formed in each gear (for example, JP No. 8-147811 A).

### SUMMARY

A gear structure according to an aspect of the present disclosure includes: two gears meshing with each other to transmit power, wherein in one of the two gears, some of a plurality of teeth are partially missing in a tooth width direction, and the other of the two gears has engaging portions that engage with the missing tooth portions at inter-teeth portions corresponding to the partially missing teeth among a plurality of inter-teeth portions.

### BRIEF DESCRIPTION OF THE DRAWINGS

FIG. 1 is a perspective view of a medium processing device;

FIG. 2 is a perspective view illustrating a processing part driving mechanism and a carriage;

FIG. 3 is a perspective view illustrating a connection plate and a final gear included in the processing part driving mechanism;

FIG. 4 is a perspective view illustrating a second transmission part included in the processing part driving mechanism;

FIG. 5 is a cross-sectional view of the processing part driving mechanism and the carriage;

FIG. 6 is a cross-sectional view of the medium processing device in a state in which the carriage is at a processing position;

FIG. 7 is a cross-sectional view of the medium processing device in a state in which the carriage is at a retracted position;

FIG. 8 is a perspective view illustrating the processing part driving mechanism in a state in which the carriage is at a processing position;

FIG. 9 is a perspective view illustrating phases of the second transmission part and the final gear in a state in which the carriage is at the processing position;

FIG. 10 is a perspective view illustrating phases of the second transmission part and the final gear in a state in which the carriage is at the processing position; and

FIG. 11 is a perspective view illustrating the processing part driving mechanism in a state in which the carriage is at the retracted position.

### DETAILED DESCRIPTION

Hereinafter, modes for carrying out the present disclosure will be described in detail with reference to the drawings. In the present embodiment, a gear structure of the present disclosure is applied to a medium processing device 10. The X-axis direction, the Y-axis direction, and the Z-axis direction illustrated in each drawing are directions perpendicular to each other. In a state where the medium processing device 10 is placed on a horizontal placement surface, the X-axis direction and the Y-axis direction are the horizontal direction, and the Z-axis direction is the vertical direction (height direction of the medium processing device 10). In addition, the +Z direction side is an upper side, and the −Z direction side is a lower side.

Providing a means for phase matching such as a hole or a pin to perform phase matching of gears has a problem that the configuration becomes complicated.

An object of the present disclosure is to provide a gear structure capable of phase matching of gears with a simple configuration.

The medium processing device 10 presses a processing part against a sheet surface S1, which is the upper surface of a sheet-like to-be-processed medium S (medium), to perform predetermined processing on the to-be-processed medium S. In the medium processing device 10, a first operation of moving the processing part in the X-axis direction (first direction) along the sheet surface S1 of the to-be-processed medium S, a second operation of changing the height position (distance in the Z-axis direction with respect to the sheet surface S1) of the processing part from the sheet surface S1 of the to-be-processed medium S, and a third operation of relatively moving the to-be-processed medium S with respect to the processing part in the Y-axis direction (second direction) intersecting the X-axis direction can be combined to perform processing on the to-be-processed medium S in an arbitrary trajectory. The to-be-processed medium S is supplied to the medium processing device 10 in an overlapping manner on a mount T.

The main body 11 of the medium processing device 10 includes a pair of side plates 11a and 11b arranged at an interval in the X-axis direction, and an inner plate 11c extending in the X-axis direction and connecting the pair of side plates 11a and 11b. On the −Y direction side of the main body 11, a tray 12 which is a pedestal on which the to-be-processed medium S is placed is provided. A conveying roller 13 and a conveying roller 14 extending in the X-axis direction are supported between the pair of side plates 11a and 11b. The conveying roller 13 and the conveying roller 14 are disposed side by side in the Z-axis direction and are rotatable about an axial center extending in the X-axis direction. The conveying roller 13 is supported by a pair of roller support plates 15 on both sides which are rotatable with respect to the side plate 11a and the side plate 11b. Each of the roller support plates 15 is biased by a roller biasing spring 16 in a direction in which the conveying roller 13 approaches the conveying roller 14, and the to-be-processed medium S can be sandwiched between a large-diameter nipping portion 13a of the conveying roller 13 and a nipping portion 14a of the conveying roller 14. The conveying roller 14 is rotated by power generated by a roller driving motor 17 attached to a side portion of the side plate 11a. When the conveying roller 14 is rotated with the to-be-processed medium S sandwiched between the nipping portion 13a and the nipping portion 14a, the to-be-processed medium S is conveyed in the Y-axis direction. The conveyance direction of the to-be-processed medium S in the Y-axis direction can be switched by controlling the roller driving motor 17 to switch the rotation direction of the conveying roller 14. At least the conveying roller 13, the conveying roller 14, and the roller driving motor 17 constitute a medium conveying mechanism 18 that conveys the to-be-processed medium S in the Y-axis direction. The medium conveying mechanism 18 constitutes a relative moving mechanism that relatively moves the to-be-processed medium S with respect to the processing part in the Y-axis direction.

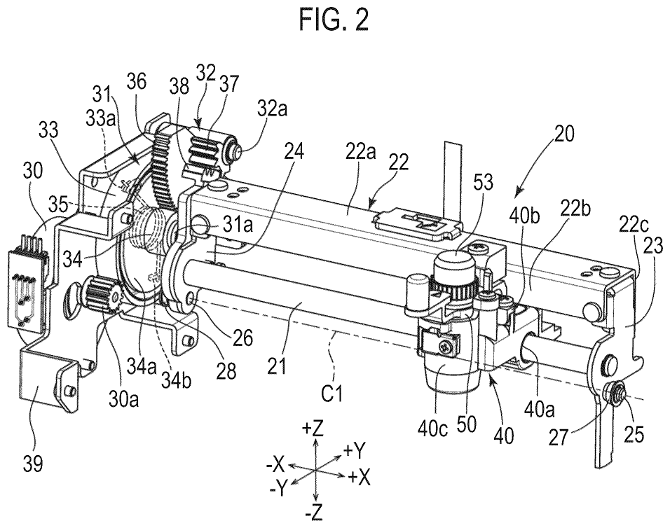

A processing part driving mechanism 20 illustrated in FIG. 2 can perform the first operation of supporting the processing part for processing the to-be-processed medium S and moving the processing part in the X-axis direction along the to-be-processed medium S, and the second operation of changing the height position (an interval in the Z-axis direction with respect to the sheet surface S1) of the processing part from the sheet surface S1 of the to-be-processed medium S. The processing part driving mechanism 20 includes a driving belt 43, a pulley 44, a pulley 45, a belt driving motor 46, and the like, which will be described later, in addition to the configuration illustrated in FIG. 2.

The processing part driving mechanism 20 includes a guide member 21 that is a columnar shaft member extending in the X-axis direction, a transmission member 22 that is an elongated member extending in the X-axis direction, and a pair of connection plates 23 and 24 that are connection members that connect ends on both sides of the guide member 21 and the transmission member 22. Ends on the +X direction side of the guide member 21 and the transmission member 22 are fixed to the connection plate 23, and ends on the −X direction side of the guide member 21 and the transmission member 22 are fixed to the connection plate 24. A support shaft 25 provided on the connection plate 23 protrudes toward the +X direction side, and the support shaft 25 is rotatably supported through a bearing 27 provided on the side plate 11a of the main body 11. A support shaft 26 provided on the connection plate 24 protrudes toward the −X direction side, and the support shaft 26 is rotatably supported through a bearing 28 provided on the side plate 11b of the main body 11. The axial center of the support shaft 25 and the axial center of the support shaft 26 are located on the same axial center C1 extending in the X-axis direction, and a rotary operation unit including the guide member 21, the transmission member 22, the connection plate 23, and the connection plate 24 is rotatably supported with respect to the main body 11 about the axial center C1.

A lifting drive motor 30, which is a driving means for changing the height position of the processing part with respect to the sheet surface S1 of the to-be-processed medium S, is attached to the side portion of the side plate 11b. A pinion 30a is provided on an output shaft of the lifting drive motor 30, and rotation of the pinion 30a is transmitted to the connection plate 24 via a speed reduction mechanism to rotate the rotary operation unit about the axial center C1. The speed reduction mechanism includes a first transmission portion 31, a second transmission portion 32, and a final gear 38. The main body 11 includes a support bracket 39 disposed on the −X direction side of the side plate 11b and fixed to the side plate 11b, and the lifting drive motor 30, the first transmission portion 31, and the second transmission portion 32 are supported through the support bracket 39.

The first transmission portion 31 is a double gear including a large-diameter gear 33 and a small-diameter gear 34 coaxially. The large-diameter gear 33 and the small-diameter gear 34 are supported so as to be relatively rotatable about a support shaft 31a provided on the support bracket 39 and extending in the X-axis direction. On the outer peripheral surface of the large-diameter gear 33, a tooth portion (gear surface) meshing with the pinion 30a is formed. The small-diameter gear 34 has a smaller diameter than the large-diameter gear 33, and a tooth portion (gear surface) is formed on the outer peripheral surface of the small-diameter gear 34. A transmission portion 34a of the small-diameter gear 34 is accommodated inside the large-diameter gear 33. One end and the other end of a torsion spring 35 are engaged with a spring hooking portion 33a provided inside the large-diameter gear 33 and a spring hooking portion 34b provided in the transmission portion 34a of the small-diameter gear 34. When the large-diameter gear 33 rotates, the deflection amount of the torsion spring 35 increases, and when the torsion spring 35 reaches a predetermined deflection amount, the rotation is transmitted from the large-diameter gear 33 to the small-diameter gear 34 via the torsion spring 35. That is, in the state in which the rotation is transmitted from the large-diameter gear 33 to the small-diameter gear 34, the spring force of the torsion spring 35 is charged.

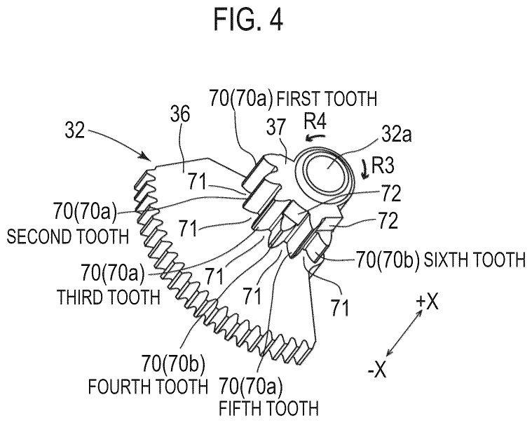

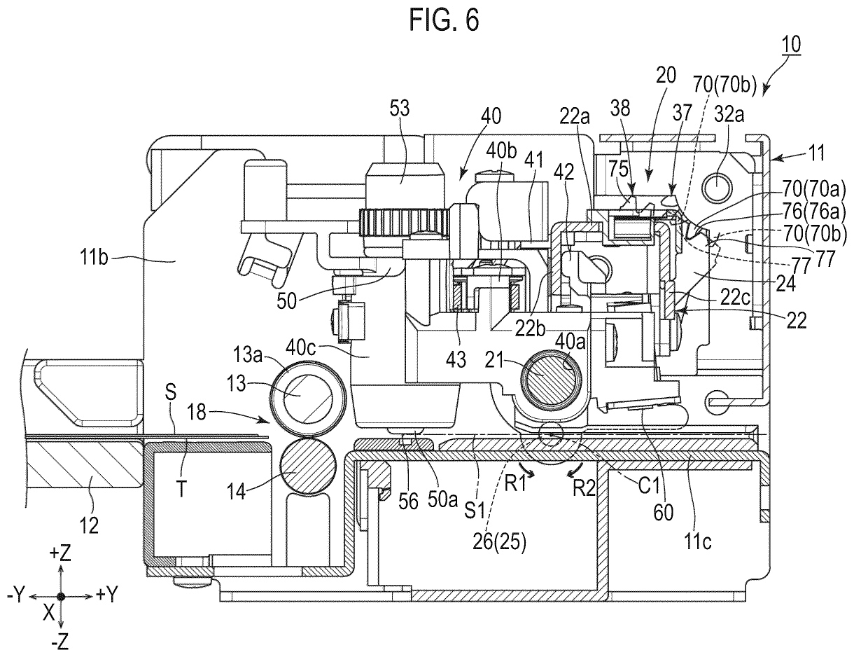

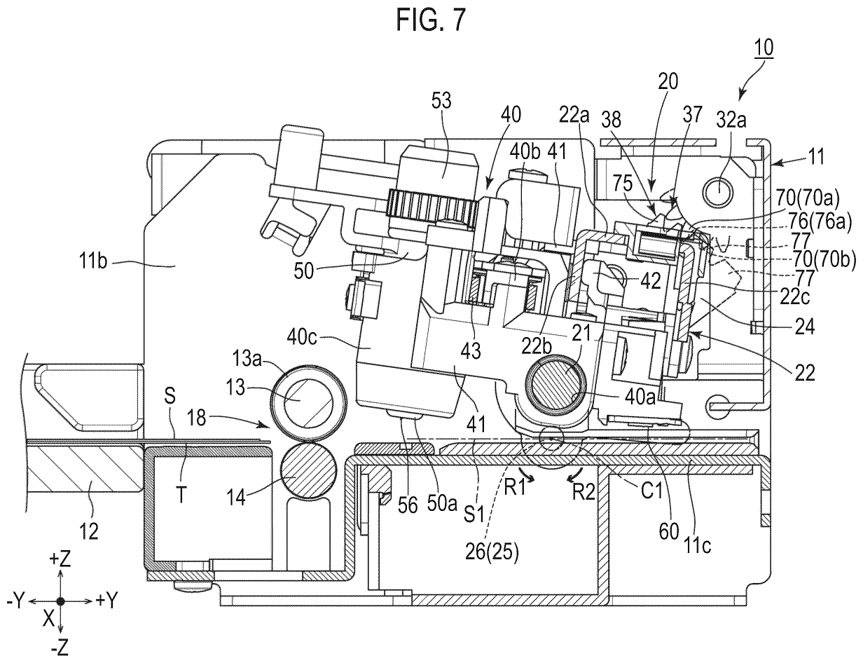

As illustrated in FIG. 4, the second transmission portion 32 is a double gear including a large-diameter gear 36 and a small-diameter gear 37 coaxially. The large-diameter gear 36 and the small-diameter gear 37 are supported so as to rotate integrally about a support shaft 32a provided on the support bracket 39 and extending in the X-axis direction. A tooth portion (gear surface) meshing with the small-diameter gear 34 of the first transmission portion 31 is formed on the outer peripheral surface of the large-diameter gear 36. The small-diameter gear 37 has a smaller diameter than the large-diameter gear 36, and a tooth portion (gear surface) is formed on the outer peripheral surface of the small-diameter gear 37. Each of the large-diameter gear 36 and the small-diameter gear 37 is a fan-shaped partial gear (sector gear) having a tooth portion only in a part of the circumference having the shaft center of the support shaft 32a serving as the rotation center as a center. By configuring the second transmission portion 32 with such a partial gear, the area of each of the gears 36 and 37 can be reduced, and the medium processing device 10 can be downsized. In particular, the second transmission portion 32 is located in the vicinity of end portions (corner portions) of the main body 11 on the +Y direction side and the +Z direction side in a state of being viewed from the side in the X-axis direction as illustrated in FIGS. 6 and 7, and the second transmission portion 32 is prevented from protruding in the Y-axis direction and the Z-axis direction with respect to the main body 11 by configuring the large-diameter gear 36 and the small-diameter gear 37 as partial gears, and thus it is possible to realize downsizing of the medium processing device 10.

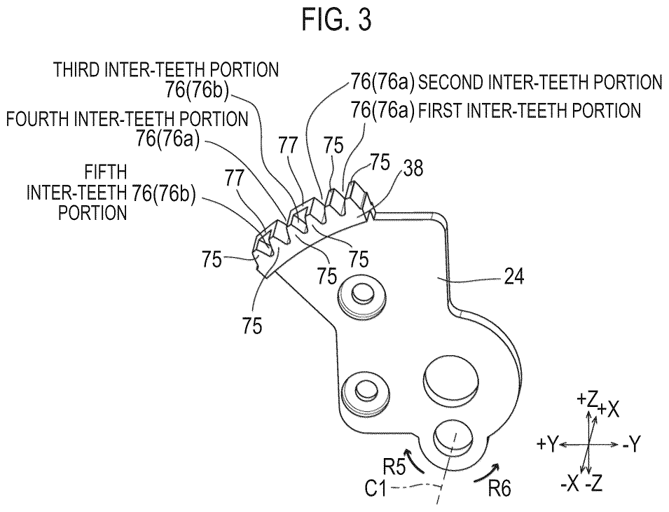

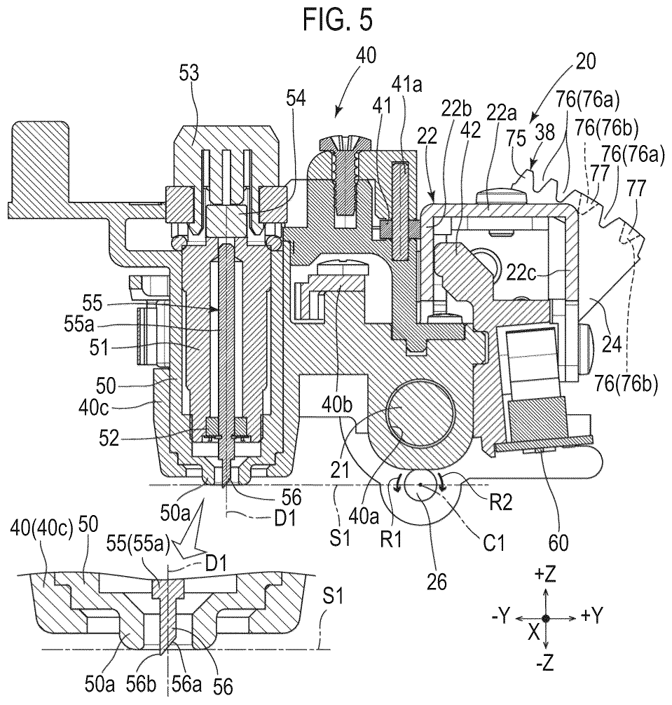

As illustrated in FIG. 3, a final gear 38 is integrally formed with the connection plate 24. More specifically, the final gear 38 is formed at one end of the connection plate 24. The final gear 38 is a fan-shaped partial gear (sector gear) having a tooth portion only in a part of the circumference having the axial center C1 which is the rotation center of the connection plate 24 as a center. By configuring the final gear 38 as such a partial gear, the area of the final gear 38 can be reduced, and the medium processing device 10 can be downsized. The final gear 38 of the connection plate 24 meshes with the small-diameter gear 37 of the second transmission portion 32. The small-diameter gear 37 and the final gear 38 are two gears constituting the gear structure of the present disclosure and mesh with each other to transmit power from the small-diameter gear 37 on the drive side to the final gear 38 on the driven side. Details of the gear structure including the small-diameter gear 37 and the final gear 38 will be described later. When the pinion 30a is rotated by driving the lifting drive motor 30, power is transmitted by the speed reduction mechanism including the first transmission portion 31, the second transmission portion 32, and the final gear 38, and the rotary operation unit including the guide member 21, the transmission member 22, the connection plate 23, and the connection plate 24 rotates about the axial center C1. By controlling the lifting drive motor 30 to switch the rotation direction of the pinion 30a, the rotation direction of the rotary operation unit can be switched between a first rotation direction R1 and a second rotation direction R2 (refer to FIGS. 5 to 7). When the rotary operation unit is rotated in the first rotation direction R1, the processing part supported by the rotary operation unit is pressed against the to-be-processed medium S. The pressing load of the processing part with respect to the to-be-processed medium S is set according to the force of the torsion spring 35 provided in the first transmission portion 31.

A carriage 40, which is a support portion that supports the processing part, is supported via the guide member 21 and the transmission member 22 extending in the X-axis direction. As illustrated in FIG. 5, the carriage 40 has a guided hole 40a penetrating in the X-axis direction, and the guide member 21 is inserted into the guided hole 40a. The carriage 40 is supported to be movable in the X-axis direction via the guide member 21. The force rotating about the axial center C1 is transmitted from the transmission member 22 to the carriage 40, and the carriage 40 rotates about the axial center C1 together with the guide member 21 and the transmission member 22. The movement of the carriage 40 in the X-axis direction along the guide member 21 is defined as a first operation, and the rotation of the carriage 40 about the axial center C1 is defined as a second operation. The second operation is set as an operation of integrally changing the height position of the processing part (a knife 56 which will be described later) from the sheet surface S1 with the guide member 21 and the carriage 40 along with the rotation of the support shaft 25 and the support shaft 26 about the axial center C1. A position detection sensor 60 is provided on the lower surface of the carriage 40. The position detection sensor 60 is a non-contact sensor that optically detects an alignment mark (registration mark) provided on the mount T or the to-be-processed medium S.

The transmission member 22 is a U-shaped cross-sectional member having an upper plate portion 22a, a front plate portion 22b, and a rear plate portion 22c each of which is a flat plate-shaped wall portion. The front plate portion 22b extends downward from the edge on the −Y direction side of the upper plate portion 22a, and the rear plate portion 22c extends downward from the edge on the +Y direction side of the upper plate portion 22a. The carriage 40 supports a bearing 41 rotatable via a support shaft 41a extending substantially perpendicular to the X-axis direction. The carriage 40 has a protrusion 42 that enters the inside of the transmission member 22. The bearing 41 and the protrusion 42 are in contact with the front plate portion 22b of the transmission member 22 so as to be relatively movable in the X-axis direction. When the transmission member 22 performs the second operation that is rotation about the axial center C1, force is transmitted from the front plate portion 22b to the bearing 41 and the protrusion 42, and the carriage 40 rotates about the axial center C1 together with the transmission member 22. More specifically, when the bearing 41 is pressed by the front plate portion 22b of the transmission member 22, the carriage 40 rotates in the first rotation direction R1, and when the protrusion 42 is pressed by the front plate portion 22b of the transmission member 22, the carriage 40 rotates in the second rotation direction R2.

The driving belt 43 is connected to a belt connection portion 40b of the carriage 40. The driving belt 43 is an endless belt stretched between the pulley 44 supported by the side plate 11a and the pulley 45 supported by the side plate 11b, and has a loop structure in which the driving belt 43 turns between the pulley 44 and the pulley 45. The pulley 44 is rotated by power generated by the belt driving motor 46 attached to the side portion of the side plate 11a. When the pulley 44 is rotated by driving of the belt driving motor 46, the driving belt 43 moves in the X-axis direction to transmit force to the belt connection portion 40b, thereby moving the carriage 40 in the X-axis direction. The moving direction of the carriage 40 in the X-axis direction can be switched by controlling the belt driving motor 46 to switch the rotation direction of the pulley 44.

As described above, in the processing part driving mechanism 20, the carriage 40 can be caused to rotate about the axial center C1 (the second operation) by driving the lifting drive motor 30. Further, the movement (first operation) of the carriage 40 in the X-axis direction can be performed by driving the belt driving motor 46. A holder attaching/detaching portion 40c for detachably holding the processing part holder 50 is provided at a portion of the carriage 40 on the −Y direction side. The holder attaching/detaching portion 40c and the processing part holder 50 are tubular, and the processing part holder 50 is inserted into the holder attaching/detaching portion 40c. An annular protrusion 50a protruding to the −Z direction side from the holder attaching/detaching portion 40c is formed at an end portion of the processing part holder 50 on the −Z direction side.

Various processing parts for processing the to-be-processed medium S can be attached to the processing part holder 50. The present embodiment illustrates a case in which a knife 56, which is a cutting tool for cutting the to-be-processed medium S, is attached as the processing part. The knife 56 is attached to the processing part holder 50 using the knife holder 51. The knife holder 51 has a tubular shape that can be inserted into the processing part holder 50. A male screw formed on the outer peripheral surface near the lower end of the knife holder 51 is screwed into a female screw formed inside the processing part holder 50, whereby the knife holder 51 is fixed to the processing part holder 50.

An accommodation hole extending in the axial direction of the knife holder 51 is formed inside the knife holder 51, and an annular knife bearing 52 is attached near an end portion of the accommodation hole on the −Z direction side. A cap 53 is attached to the end of the knife holder 51 on the +Z direction side, and a magnet 54 is supported between the knife holder 51 and the cap 53. The knife unit 55 is inserted into the accommodation hole of the knife holder 51. The knife unit 55 has a rod-shaped shaft portion 55a, and the knife 56 that is a cutting tool is fixed to the end portion of the shaft portion 55a on the −Z direction side. The shaft portion 55a of the knife unit 55 is supported via the knife bearing 52 in the knife holder 51 so as to be rotatable about a blade axis D1. An end of the shaft portion 55a of the knife unit 55 on the +Z direction side is located in the vicinity of the magnet 54. At least the shaft portion 55a of the knife unit 55 is made of a magnetic material and is attracted toward the +Z direction side by the magnetic force of the magnet 54, and a state in which the knife unit 55 is inserted into the accommodation hole of the knife holder 51 is maintained.

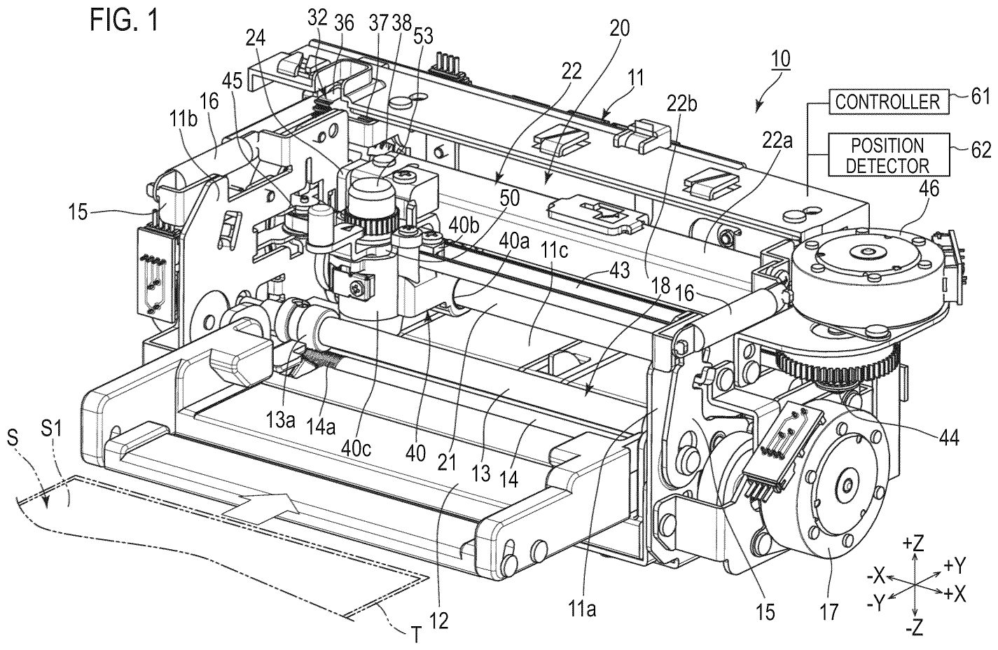

In a state in which the knife unit 55 is attached to the knife holder 51, the knife 56 protrudes from the knife holder 51 toward the −Z direction side. As illustrated in an enlarged view in FIG. 5, the knife holder 51 is fixed in the processing part holder 50 such that the tip of the knife 56 slightly protrudes in the −Z direction from the tip of the annular protrusion 50a of the processing part holder 50. For example, the protrusion amount of the knife 56 is set such that the knife 56 penetrates the to-be-processed medium S in the Z-axis direction and does not penetrate the mount T. The knife 56 has a ridge-shaped blade edge surface 56a inclined with respect to the blade axis D1, and the blade axis D1 passes through an intermediate position of the blade edge surface 56a. Therefore, the tip portion 56b located on the most −Z direction side of the knife 56 is located at a position shifted from the blade axis D1 in the direction perpendicular to the blade axis D1. The medium processing device 10 includes a controller 61 (refer to FIG. 1). The controller 61 includes a processor such as a central processing unit (CPU) and a storage, and controls the operation of each part of the medium processing device 10 by the processor reading a program stored in the storage and executing the program. The controller 61 controls at least operations of the roller driving motor 17, the lifting drive motor 30, and the belt driving motor 46. A detection signal of the position detection sensor 60 is input to the controller 61.

The medium processing device 10 includes a position detector 62 that detects a rotational position of the transmission member 22 and the carriage 40 about the axial center C1 (refer to FIG. 1). For example, the position detector 62 includes an optical sensor such as a photointerrupter, and detection is performed at the moment when a part of the transmission member 22 or the carriage 40 passes between a light projecting part and a light receiving part of the photointerrupter and light is blocked. A detection signal of the position detector 62 is input to the controller 61.

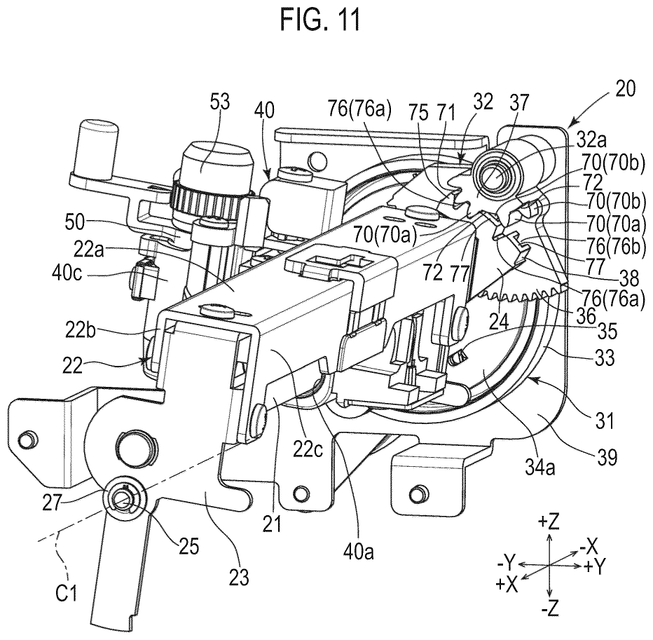

The position detector 62 detects a retracted position (FIG. 7 and FIG. 11) of the transmission member 22 and the carriage 40. The retracted position is a height position at which the knife 56 supported via the carriage 40, the processing part holder 50, and the knife holder 51 retracts upward from the sheet surface S1 of the to-be-processed medium S without cutting the to-be-processed medium S supported by the medium processing device 10. In the retracted position, the transmission member 22 and the carriage 40 are rotated in the second rotation direction R2, and the processing part holder 50 and the knife holder 51 are inclined in a direction (+Z direction side) in which the distance from the to-be-processed medium S in the Z axis direction is increased.

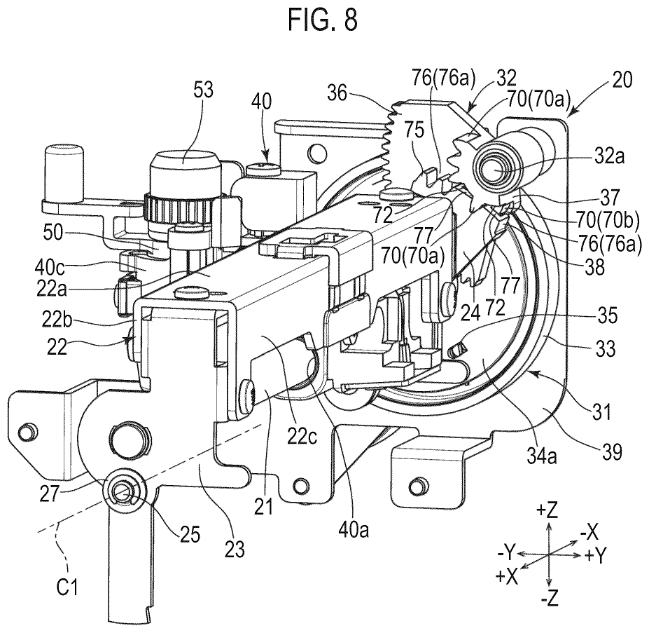

The controller 61 detects a processing position (FIG. 6 and FIG. 8) of the transmission member 22 and the carriage 40 based on the drive amount of the lifting drive motor 30 when the transmission member 22 and the carriage 40 are rotated in the first rotation direction R1 based on the retracted position detected by the position detector 62. For example, the lifting drive motor 30 is a pulse motor, and the controller 61 detects the rotation amount of the transmission member 22 and the carriage 40 in the first rotation direction R1 and the arrival at the processing position by counting the number of drive pulses of the lifting drive motor 30 that rotates in the first rotation direction R1 from the retracted position. The processing position is a height position at which the processing part (that is, the knife 56) supported via the carriage 40, the processing part holder 50, and the knife holder 51 is pressed against and processes (cuts) the to-be-processed medium S. At the processing position, the blade axis D1 of the knife unit 55 is parallel to the Z-axis direction.

As described above, in the second operation performed by the processing part driving mechanism 20, the guide member 21, the transmission member 22, the connection plate 23, and the connection plate 24 are rotated in the first rotation direction R1 about the axial center C1, and thus the carriage 40 moves toward the processing position. When the guide member 21, the transmission member 22, the connection plate 23, and the connection plate 24 are rotated in the second rotation direction R2 about the axial center C1, the carriage 40 moves toward the retracted position.

The operation of the medium processing device 10 having the above configuration will be described. At the time of attaching the to-be-processed medium S to the medium processing device 10, the controller 61 controls the lifting drive motor 30 to position the transmission member 22 and the carriage 40 at the retracted position. Subsequently, when the to-be-processed medium S is placed on the tray 12 and the to-be-processed medium S is inserted between the conveying roller 13 and the conveying roller 14, an entry detection sensor (not illustrated) detects entry of the to-be-processed medium S, the controller 61 drives the roller driving motor 17 to start rotation of the conveying roller 14, and the to-be-processed medium S is sandwiched between the nipping portion 13a of the conveying roller 13 and the nipping portion 14a of the conveying roller 14. The controller 61 drives the roller driving motor 17 to feed the to-be-processed medium S in the Y-axis direction, drives the belt driving motor 46 to adjust the position of the carriage 40 in the X-axis direction, and detects an alignment mark of the to-be-processed medium S by the position detection sensor 60. In this state, preparation for cutting of the to-be-processed medium S by the medium processing device 10 is completed.

Cutting data for cutting the to-be-processed medium S is input to the controller 61, and cutting processing is executed based on the cutting data. In a cutting target area, the controller 61 drives the lifting drive motor 30 to rotate the transmission member 22 and the carriage 40 in the first rotation direction R1 to move them from the retracted position to the processing position. As a result, the knife 56 descends and approaches the to-be-processed medium S, and the knife 56 pressed against the sheet surface S1 cuts into the to-be-processed medium S. The controller 61 drives the belt driving motor 46 to move the carriage 40 in the X-axis direction, and drives the roller driving motor 17 to move the to-be-processed medium S in the Y-axis direction, thereby relatively moving the to-be-processed medium S and the knife 56 in the horizontal direction along the trajectory along a cutting line. In this manner, cutting is performed on the to-be-processed medium S.

The knife unit 55 is supported so as to be rotatable about the blade axis D1 with respect to the knife holder 51. Therefore, the knife 56 cut into the to-be-processed medium S is angularly adjusted around the blade axis D1 such that the direction of the blade edge surface 56a always follows the progressing direction of cutting and the tip portion 56b (refer to FIG. 5) is located on the rear side in the progressing direction due to a cutting load, a frictional force, and the like acting between the knife and the to-be-processed medium S, and cutting can be executed smoothly.

In an area other than the cutting target area, the controller 61 drives the lifting drive motor 30 to rotate the transmission member 22 and the carriage 40 in the second rotation direction R2 to move them from the processing position to the retracted position. As a result, the knife 56 moves in the +Z direction to be separated from the to-be-processed medium S, and the knife 56 does not cut into the to-be-processed medium S. When the series of cutting operations based on the cutting data is completed, the controller 61 drives the lifting drive motor 30 to rotate the transmission member 22 and the carriage 40 in the second rotation direction R2 and hold them at the retracted position. Subsequently, the controller 61 rotates the conveying roller 14 to move the mount T and the to-be-processed medium S to the −Y direction side, conveys the mount T by a sufficient distance to the extent that the mount T is separated from the space between the nipping portion 13a and the nipping portion 14a, and then stops the conveying roller 14.

As described above, in the processing part driving mechanism 20 of the medium processing device 10, the first operation of moving the carriage 40 in the X-axis direction together with the knife 56, and the second operation of rotating the carriage 40 about the axis (axial center C1) in the X-axis direction together with the knife 56 to change the height position of the knife 56 with respect to the to-be-processed medium S can be executed. Since the second operation is performed by rotation of the carriage 40 about the axial center C1 parallel to the moving direction of the carriage 40 in the first operation, the first operation and the second operation can be realized by a simple and small structure.

In the speed reduction mechanism that transmits the power of the lifting drive motor 30 when causing the carriage 40 to perform the second operation, each of the large-diameter gear 36 and the small-diameter gear 37 of the second transmission portion 32 and the final gear 38 of the connection plate 24 is configured as a partial gear having a tooth portion only in a partial range of the circumference having the rotation center as a center. Since the range of the tooth portion that can transmit power is limited, the partial gear needs to be assembled by appropriately managing the phase in the rotation direction. In particular, since both the small-diameter gear 37 and the final gear 38 meshing with each other are partial gears, it is necessary to manage phases of both the small-diameter gear 37 and the final gear 38 at the time of assembly. The gear structure of the present embodiment enables phase matching between the small-diameter gear 37 and the final gear 38 with a simple configuration, and details thereof will be described. The teeth and inter-teeth portions meshed between the small-diameter gear 37 and the final gear 38 mean, in a narrow sense, a specific set of teeth and inter-teeth portions located on a line connecting the axial center of the support shaft 32a, which is the rotation center of the small-diameter gear 37, and the axial center C1, which is the rotation center of the final gear 38. On both sides of the specific set of teeth and the inter-teeth portions, a part of the teeth enters an inter-teeth portion.

As illustrated in FIG. 4, the small-diameter gear 37 includes a plurality of teeth 70 and a plurality of inter-teeth portions 71 between the plurality of teeth 70. The plurality of teeth 70 include first teeth 70a and second teeth 70b having different lengths in the tooth width direction (X-axis direction), and the second teeth 70b are shorter in length in the tooth width direction than the first teeth 70a. That is, some of the plurality of teeth 70 are formed as the second teeth 70b partially missing in the tooth width direction. The second teeth 70b are provided in a region on the −X direction side in the range in the tooth width direction of the small-diameter gear 37, and a region adjacent to the second teeth 70b on the +X direction side is a toothless region 72 in which no tooth exists. In one embodiment, the length of the second teeth 70b in the tooth width direction is substantially half the length of the first teeth 70a in the tooth width direction. Two second teeth 70b which are teeth partially missing in the tooth width direction are formed to sandwich the first teeth 70a which are teeth not partially missing in the tooth width direction. In the present embodiment, the number of teeth 70 is six, and the number of inter-teeth portions 71 is five. A direction in which the small-diameter gear 37 rotates when the carriage 40 is rotated in the first rotation direction R1 is defined as a first transmission direction R3 (FIG. 4), and a direction in which the small-diameter gear 37 rotates when the carriage 40 is rotated in the second rotation direction R2 is defined as a second transmission direction R4 (FIG. 4). When the tooth 70 on the most leading side in the first transmission direction R3 is a first tooth and the tooth 70 on the most leading side in the second transmission direction R4 is a sixth tooth, the first, second, third, and fifth teeth 70 are configured as the first teeth 70a, and the fourth and sixth teeth 70 are configured as the second teeth 70b.

As shown in FIG. 3, the final gear 38 includes a plurality of teeth 75 and a plurality of inter-teeth portions 76 between the plurality of teeth 75. The plurality of inter-teeth portions 76 include a first inter-teeth portion 76a having a shape penetrating in the tooth width direction, and a second inter-teeth portion 76b provided with an engaging portion 77 engageable with a toothless region 72 of the small-diameter gear 37. The engaging portion 77 is provided at an end portion of the second inter-teeth portion 76b on the +X direction side, and is configured to connect two adjacent teeth 75 to fill the second inter-teeth portion 76b in a part in the tooth width direction. Since the engaging portion 77 is provided, the second inter-teeth portion 76b has a length in the tooth width direction (a length of a portion of the second inter-teeth portion 76b excluding the engaging portion 77) that can be meshed with the tooth 70 of the small-diameter gear 37, which is shorter than that of the first inter-teeth portion 76a. Two second inter-teeth portions 76b which are inter-teeth portions having the engaging portion 77 are formed to sandwich the first inter-teeth portion 76a which is an inter-teeth portion that does not have the engaging portion 77. In the present embodiment, the number of teeth 75 is six, and the number of inter-teeth portions 76 is five. A direction in which the final gear 38 rotates when the carriage 40 is rotated in the first rotation direction R1 is defined as a first transmission direction R5 (FIG. 3), and a direction in which the final gear 38 rotates when the carriage 40 is rotated in the second rotation direction R2 is defined as a second transmission direction R6 (FIG. 3). When the inter-teeth portion 76 on the most leading side in the first transmission direction R5 is defined as a first inter-teeth portion and the inter-teeth portion 76 on the most leading side in the second transmission direction R6 is defined as a fifth inter-teeth portion, the first, second, and fourth inter-teeth portions 76 are configured as the first inter-teeth portion 76a, and the third and fifth inter-teeth portions 76 are configured as the second inter-teeth portion 76b.

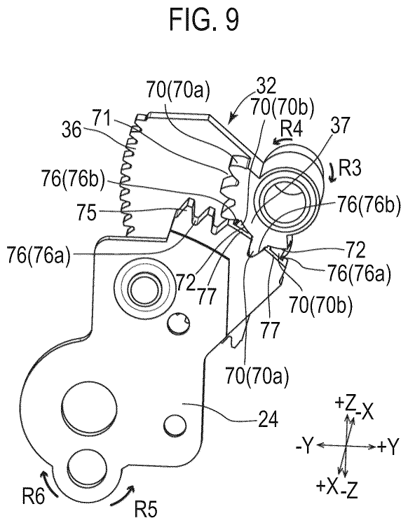

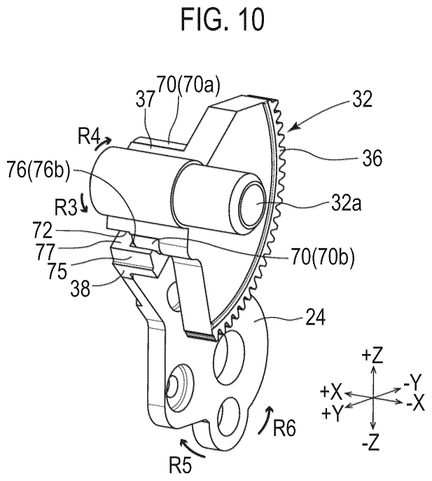

When the small-diameter gear 37 and the final gear 38 are combined, the small-diameter gear 37 and the final gear 38 are relatively moved (approached) in the X-axis direction, and the teeth 70 of the small-diameter gear 37 enter the inter-teeth portions 76 of the final gear 38. For example, the rotary operation unit including the guide member 21, the transmission member 22, the connection plate 23, and the connection plate 24 is first attached to the main body 11 (support shafts 25 and 26 are supported by bearings 27 and 28), and the support bracket 39 supporting the first transmission portion 31 and the second transmission portion 32 is moved to the +X direction side to bring the small-diameter gear 37 close to the final gear 38. At this time, as illustrated in FIG. 9 and FIG. 10, the second teeth 70b of the small-diameter gear 37 and the second inter-teeth portions 76b of the final gear 38 are aligned in phase. That is, the tooth end surface of the second tooth 70b on the +X direction side and the engaging portion 77 are brought into a state of facing each other in the X-axis direction. The phase matching between the second teeth 70b and the second inter-teeth portions 76b is not limited to the positional relationship in which only the set of second teeth 70b and the second inter-teeth portions 76b are completely meshed, and it is sufficient that the positional relationship in which the second teeth 70b can enter the second inter-teeth portions 76b without being hindered by the teeth 75 on the final gear 38 side is maintained. For example, in the state illustrated in FIG. 9 and FIG. 10, the phases match in such an arrangement that parts of the two second teeth 70b simultaneously enter the corresponding two second inter-teeth portions 76b. After phase matching is performed in this manner, the small-diameter gear 37 and the final gear 38 are relatively moved in the X axis direction to a position where the engaging portion 77 located on the +X direction side of the second inter-teeth portions 76b is engaged with the toothless region 72 located on the +X direction side of the second teeth 70b. When the two toothless regions 72 and the two engaging portions 77 reach the state of engagement, a set of first teeth 70a (fifth teeth 70) and first inter-teeth portions 76a (fourth inter-teeth portions 76) disposed therebetween mesh with each other. In this manner, by matching the phases of the second teeth 70b and the second inter-teeth portions 76b and then combining them, the small-diameter gear 37 and the final gear 38 can be meshed in an appropriate positional relationship.

On the other hand, when the small-diameter gear 37 and the final gear 38 are relatively moved (brought close) in the X-axis direction in a state in which the phases of the second teeth 70b and the second inter-teeth portions 76b are not matched, that is, in a state in which the first teeth 70a are positioned on extension in the X-axis direction with respect to the second inter-teeth portions 76b, the engaging portion 77 and the first teeth 70a abut on each other, and the movement is restricted in the middle. As a result, the small-diameter gear 37 and the final gear 38 cannot reach a normal combination position in the tooth width direction. In a state in which the small-diameter gear 37 and the final gear 38 are shifted in the tooth width direction with respect to the normal combination position, the second transmission portion 32 and the connection plate 24 do not fit at the design positions in the medium processing device 10, and the processing part driving mechanism 20 cannot be appropriately assembled. Therefore, the engagement portion 77 functions as a stopper that restricts the movement in the tooth width direction, and it is possible to prevent the small-diameter gear 37 and the final gear 38 from being assembled with an inappropriate phase. In addition, since the assembly of the processing part driving mechanism 20 cannot be completed, it is possible to cause an operator to recognize that the small-diameter gear 37 and the final gear 38 are not in an appropriate phase. If the small-diameter gear 37 and the final gear 38 are assembled with an inappropriate phase, there is a possibility that the carriage 40 cannot be moved to the processing position and the retracted position via the small-diameter gear 37 and the final gear 38 having a limited number of teeth. Alternatively, the small-diameter gear 37 and the final gear 38 may protrude in the Y-axis direction or the Z-axis direction and interfere with a peripheral structure.

As described above, since the tooth portion in the gear structure including the small-diameter gear 37 and the final gear 38 is configured such that meshing is established only when a specific phase is selected, it is possible to reliably perform phase matching between the small-diameter gear 37 and the final gear 38 with a simple configuration without separately preparing a phase matching means. In the means for phase matching, in the small-diameter gear 37 as one gear, some of the plurality of teeth 70 (the second teeth 70b) are configured to be partially missing in the tooth width direction (having the toothless region 72), and in the final gear 38 as the other gear, the inter-teeth portions (the second inter-teeth portions 76b) corresponding to the partially missing teeth (the second teeth 70b) among the plurality of inter-teeth portions 76 are configured to include the engaging portion (the engaging portion 77) to be engaged with the missing portion (the toothless region 72), and thus it is not necessary to change the basic shapes of the small-diameter gear 37 and the final gear 38, and the gear structure does not become large.

When the carriage 40 is rotated to the processing position and the retracted position, the teeth 70 of the small-diameter gear 37 meshing with the inter-teeth portions 76 of the final gear 38 sequentially change. FIG. 8 to FIG. 10 illustrate the phases of the small-diameter gear 37 and the final gear 38 at the processing position of the carriage 40. At the processing position of the carriage 40, the first tooth 70a (tooth 70 not partially missing, fifth tooth 70 from the leading side of the small-diameter gear 37 in the first transmission direction R3) located between two second teeth 70b (partially missing tooth 70) among the plurality of teeth 70 of the small-diameter gear 37 meshes with the first inter-teeth portion 76a (inter-teeth portion 76 not having the engaging portion 77, the fourth inter-teeth portion 76 from the leading side of the final gear 38 in first transmission direction R5) located between two second inter-teeth portions 76b (inter-teeth portions 76 having the engagement portion 77) among the plurality of inter-teeth portions 76 of the final gear 38. At the processing position of the carriage 40, processing is performed in a pressure contact state in which the processing part (for example, knife 56) is pressed against the to-be-processed medium S, and thus the processing part receives a reaction force from the to-be-processed medium S toward the +Z direction side. By causing the state in which the first tooth 70a having a large length in the tooth width direction meshes with the first inter-teeth portion 76a to correspond to the processing position of the carriage 40, it is possible to reliably transmit the force for pressing the processing part against the reaction force to the carriage 40.

FIG. 11 illustrates phases of the small-diameter gear 37 and the final gear 38 at the retracted position of the carriage 40. At the retracted position of the carriage 40, among the plurality of teeth 70 of the small-diameter gear 37, the first tooth 70a (the third tooth 70 from the leading side of the small-diameter gear 37 in the first transmission direction R3) different from the tooth meshed with the first inter-teeth portion 76a at the processing position meshes with the first inter-teeth portion 76a (the second inter-teeth portion 76 from the leading side of the final gear 38 in the first transmission direction R5). At the processing position, it is necessary to reliably transmit the pressure for pressing the processing part against the to-be-processed medium S to the carriage 40, and thus the first tooth 70a having a large length in the tooth width direction and the first inter-teeth portion 76a mesh with each other as described above. On the other hand, at the retracted position, it is sufficient that there is a fitting force enough to withstand the movement of the carriage 40 between the small-diameter gear 37 and the final gear 38, and meshing between the first teeth 70a and the first inter-teeth portions 76a is not essential, but the carriage 40 can be held more stably by meshing the first teeth 70a and the first inter-teeth portions 76a even at the retracted position.

In the middle of rotating the carriage 40 to the processing position and the retracted position, the second tooth 70b (fourth tooth from the leading side of the small-diameter gear 37 in the first transmission direction R3) among the plurality of teeth 70 of the small-diameter gear 37 meshes with the second inter-teeth portion 76b (third inter-teeth portion 76 from the leading side of the final gear 38 in the first transmission direction R5). In the middle of transition of the carriage 40 from the processing position to the retracted position, the processing part is not in pressure contact with the to-be-processed medium S, and the reaction force from the to-be-processed medium S to the processing part does not act, and thus required torque is smaller than that at the processing position. In addition, a load for continuing the rotation of the carriage 40 after the carriage 40 starts to rotate is smaller than that in an initial stage in which the carriage 40 starts to rotate from the processing position or the retracted position. Therefore, at an intermediate stage between the processing position and the retracted position, the second tooth 70b having a short length in the tooth width direction and the second inter-teeth portion 76b mesh with each other, and thus the rotational force can be transmitted to the final gear 38 without any trouble.

As described above, the two second teeth 70b, which are teeth partially missing in the tooth width direction, are formed on the small-diameter gear 37, which is one of the gears, to sandwich the first tooth 70a, which is a tooth partially not missing in the tooth width direction, and the two second inter-teeth portions 76b, which are inter-teeth portions 76 having the engaging portions 77, are formed on the final gear 38, which is the other gear, to sandwich the first inter-teeth portion 76a, which is an inter-teeth portion 76 having no engaging portion 77. When the knife 56 serving as a processing part is pressed against the to-be-processed medium S, the first tooth 70a at the position sandwiched between the two second teeth 70b and the first inter-teeth portion 76a at the position sandwiched between the two second inter-teeth portions 76b mesh with each other, and thus the force for pressing the knife 56 against the to-be-processed medium S can be reliably transmitted to the carriage 40.

FIG. 9 and FIG. 10 illustrate the phases of the small-diameter gear 37 and the final gear 38 (phases corresponding to the processing position of the carriage 40) when the two toothless regions 72 and the two engaging portions 77 are engaged with each other by substantially equal engagement amounts, but at the time of assembly, if at least one set of the toothless regions 72 and the engaging portions 77 are engaged with each other, appropriate phase matching between the small-diameter gear 37 and the final gear 38 is established. Therefore, at the time of phase matching at the time of assembly, phase matching between the small-diameter gear 37 and the final gear 38 may be performed at a position slightly shifted in the rotational direction from the relative positional relationship illustrated in FIG. 9 and FIG. 10. Specifically, the small-diameter gear 37 and the final gear 38 may be combined in a phase in a state in which one second tooth 70b (fourth tooth from the leading side of the small-diameter gear 37 in the first transmission direction R3) meshes with one second inter-teeth portion 76b (third inter-teeth portion 76 from the leading side of the final gear 38 in the first transmission direction R5) at the rotational position in the middle of the processing position and the retracted position described above.

In addition, as long as at least one set of the toothless region 72 and the engaging portion 77 is provided, the phases of the small-diameter gear 37 and the final gear 38 can be matched at the time of assembling the gear structure, and thus unlike the above embodiment, the number of toothless regions 72 (second teeth 70b) and the number of engaging portions 77 (second inter-teeth portions 76b) in the gear structure may be only one. Alternatively, three or more of the toothless regions 72 (second teeth 70b) and the engaging portions 77 (second inter-teeth portions 76b) may be provided. In the above embodiment, when the processing part is pressed against the to-be-processed medium S, the two toothless regions 72 (second teeth 70b) and the two engaging portions 77 (second inter-teeth portions 76b) are arranged on both sides of the meshed first tooth 70a and first inter-teeth portion 76a (refer to FIG. 8 and FIG. 9), but the arrangement of the toothless regions 72 (second teeth 70b) and the engaging portions 77 (second inter-teeth portions 76b) is not limited to this configuration. For example, when the processing part is pressed against the to-be-processed medium S, instead of the second tooth 70b and the second inter-teeth portion 76b, another first tooth 70a and another first inter-teeth portion 76a may be disposed on one side or both sides of the meshed first tooth 70a and first inter-teeth portion 76a.

The above embodiments have been given as specific examples to facilitate understanding of the invention, and the present disclosure is not limited to these embodiments, and various modifications and changes can be made without departing from the gist of the invention.

In the gear structure of the above embodiment, the teeth (the second teeth 70b) partially missing in the tooth width direction are provided in the small-diameter gear 37 on the driving side that receives the power from the lifting drive motor 30 first, and the engaging portion (the engaging portion 77) to be engaged with the portion (the toothless region 72) where the teeth are missing is provided in the final gear 38 on the driven side to which the power is transmitted from the small-diameter gear 37, but conversely, the teeth partially missing in the tooth width direction may be provided in the second gear on the driven side, and the engaging portion to be engaged with the portion where the teeth are missing may be provided in the first gear on the driving side. That is, one gear and the other gear in the present disclosure do not limit the power transmission order, and either one of the two gears may be on the driving side or either one may be on the driven side. In addition, the number of teeth and the number of inter-teeth portions in each gear may be different from the number of teeth and the number of inter-teeth portions in the small-diameter gear 37 and the final gear 38 of the above embodiment.

Although the processing part driving mechanism 20 of the above embodiment causes the carriage 40 to perform the first operation of moving in the X-axis direction and the second operation of changing the height position of the processing part with respect to the to-be-processed medium S, the mechanism that causes the first operation and the mechanism that causes the second operation may be configured as separate mechanisms. Further, the processing part driving mechanism 20 of the above embodiment causes the second operation to be performed by rotation of the carriage 40 about the axial center C1 extending in the X-axis direction, but may cause the second operation to be performed by linear movement in the Z-axis direction. That is, the processing part driving mechanism of the present disclosure is only required to change the position of the processing part at least in the height direction with respect to the medium.

In the medium processing device 10 of the above embodiment, the processing part driving mechanism 20 does not move the processing part in the Y-axis direction (except for a slight positional change in the Y-axis direction due to rotation of the second operation), but moves the to-be-processed medium S in the Y-axis direction by the medium conveying mechanism 18. However, the means for relatively moving the to-be-processed medium S and the processing part in the Y-axis direction is not limited to the configuration of the above embodiment, and the processing part may be configured to move in the Y-axis direction. For example, the portion corresponding to the side plate 11a and the side plate 11b may be configured to be movable in the Y-axis direction, and the entire processing part including the carriage 40 may be moved in the Y-axis direction. Therefore, the medium conveying mechanism 18 of the above embodiment is an example of a relative moving mechanism that relatively moves the to-be-processed medium S and the processing part in the second direction, and a relative moving mechanism in a form other than this can also be applied.

The type of processing performed on the to-be-processed medium S is not limited to cutting with a knife. That is, the processing part is not limited to a knife. For example, the knife holder 51 can be removed from the processing part holder 50, and instead, a writing tool can be attached to the processing part holder 50 to perform drawing processing using the writing tool on the to-be-processed medium S. Further, it is also possible to select a processing part other than the knife or the writing tool and perform processing other than cutting and drawing on the to-be-processed medium S. It is also possible to adopt a configuration in which the processing part holder 50 is removed from the holder attaching/detaching portion 40c of the carriage 40, and a processing part such as a writing tool is directly attached to the holder attaching/detaching portion 40c. Furthermore, the gear structure of the present disclosure can also be applied to various devices and power transmission mechanisms other than the medium processing device 10.

According to the present disclosure, it is possible to provide a gear structure capable of phase matching of gears with a simple configuration.

What is claimed is:

1. A gear structure comprising:
two gears meshing with each other to transmit power, wherein
in one of the two gears, some of a plurality of teeth are partially missing in a tooth width direction, and
the other of the two gears has engaging portions that engage with the missing tooth portions at inter-teeth portions corresponding to the partially missing teeth among a plurality of inter-teeth portions.

2. The gear structure according to claim 1, wherein
at least two second teeth that are the partially missing teeth are formed in one of the two gears to sandwich a first tooth that is not partially missing in the tooth width direction, and
at least two second inter-teeth portions that are inter-teeth portions having the engaging portions are formed in the other of the two gears to sandwich a first inter-teeth portion that is an inter-teeth portion not having the engaging portion.

3. The gear structure according to claim 1, wherein
each of the one gear and the other gear is a partial gear having a tooth portion only in a part of a circumference having a rotation center as a center.

4. The gear structure according to claim 1, wherein
the gear structure is used in a medium processing device,
the medium processing device includes:
a processing part configured to press against a sheet-like medium to process the medium; and
a processing part driving mechanism configured to transmit power to the processing part via the gear structure and change a height position of the processing part from the medium,
in response to the processing part being pressed against the medium, a first tooth formed on one of the two gears and being a tooth not partially missing in the tooth width direction and a first inter-teeth portion formed on the other of the two gears and being an inter-teeth portion not having the engaging portion mesh with each other.

5. A medium processing device comprising:
a gear structure including one gear in which some of a plurality of teeth are partially missing in a tooth width direction and the other gear including an engaging portion that engages with a location where the teeth are missing in inter-teeth portions corresponding to the partially missing teeth among a plurality of inter-teeth portions;
a processing part configured to press against a sheet-like medium to process the medium; and
a processing part driving mechanism configured to transmit power to the processing part via the gear structure and change a height position of the processing part from the medium.

6. The medium processing device according to claim 5, wherein
in response to the processing part being pressed against the medium, a first tooth formed on the one gear and being a tooth not partially missing in the tooth width direction and a first inter-teeth portion formed on the other gear and being an inter-teeth portion not having the engaging portion are configured to mesh with each other.
